(19) United States
(12) Patent Application Publication
(10) Pub. No.: US 2011/0218851 A1
(43) Pub. Date: Sep. 8, 2011

(54) SEARCH ENGINE OPTIMIZATION PURCHASING ECONOMIC METHOD

(76) Inventor: David Joseph O'Hanlon, Miller Place, NY (US)

(21) Appl. No.: 12/780,892

(22) Filed: May 15, 2010

Related U.S. Application Data
(63) Continuation-in-part of application No. 12/718,959, filed on Mar. 6, 2010.

(51) Int. Cl. G06Q 30/00; G06Q 10/00; G06F 17/30

(52) U.S. Cl. 705/14.43; 705/14.52; 705/14.54; 707/706; 707/E17.108; 707/E17.032

(57) ABSTRACT

A computer workflow environment includes alternate pages within a search engine, with advertising query results based upon advertiser-selected geographic limitation of predetermined geographic size. The advertiser's cost is proportional to the number of advertiser-selected geographic limitations available to a user making search query of a class correlated with the advertiser participating in at least one of the alternate pages of the search engine. The search engine contains various levels of search engine pages having mixed or fixed maxima, minima, and between results pages. Various page IP Address Binaries contain geographical location and market audience sizes, and econometric pricing across various levels search engine page states and national pages, wherein the price of advertising depends upon limitations or addition to variables, to optimize profit by allowing computer users access to affordable choices of selected advertiser, based upon sale performance.

### RELATED APPLICATIONS

This application is a continuation in part (CIP). It is a CIP claiming reference and priority date status to application Ser. No. 12/718,959, which was filed on Mar. 6, 2010.

### BACKGROUND OF INVENTION

It is well known that search engines offer types of optimization using methods based solely upon advertisers getting preferential treatment in where the advertiser first appears upon a search engine price, the location of the advertiser on the search engine results which are displayed upon a consumer user's video display depends primarily on the price that the advertiser pays to the search engine. Such a “pay to play” price orientation is detrimental to small business advertisers, who may only wish to appear locally on a portion of a search engine. To reform this “pay to play” advertising hierarchy system requires a thorough economic complete reorganization of an advertising pricing scheme.

The best search engines are vitalized by using algorithms creating data points to increase the leverage of metadata from websites offering anything from mugs to services, such as, house cleaning or organization information.

### SUMMARY OF THE INVENTION

### Data Feed Cyclical Operation

It is commonly known for search engine Google open-source code to exist for data feed operation for anyone to manipulate. However, the present invention is new and useful to exist as a highest order economic output for worldwide geographical or market analyst supply price on sale performance algorithms containing economic performance graphs on the display of an advertiser or company computer, which use a search engine organized for storage systems that use website or a resource storage and identifiers for advertisers deciding to allow their resource identifiers to be extracted from their resource server storage devices to provide cyclical queuing within constantly economic and quantitative permutated order advertisements in a search engine database accessed which user search queries provide tracking consumer preference actions by source code applied or not within said advertiser resource identifiers and cookie or Internet Protocol Address which are used to track consumer preference actions related to said advertiser's advertisement which creates optimal economic order having the search engine database advertiser resources storage location optimally satisfy immediate economic data requirement, such as, a product conversion, information time on page, service phone number call-back feature, and other economic “workings” for sorting data which is communicated automatically to the search engine database, such as but not limited to, the most useful product, information, or service metadata, accessed at website or the same in a resource storage for optimal economical tagging resources to update search engine database which is performed upon an algorithm and for the advertiser to choose mining their resource storage which is communicated to the search engine database to automatically or periodically advert newly tagged advertisement advertiser listings upon changes by the advertiser to compete to length of update time which is chosen through the use of at least some of a template designed to change listing information at the time of use and which advertisers can use to create search engine advertisements and provide information, but not limited to physical advertisement input, the price, keyword, and website information to compete and to retain economically depending tags or newly updated tags for competitive sale performance having consumer preference actions and said advertisers geographical or supply and demand fee dependent on performance for retaining said advertisements on server storage devices which data are located within search engine database at least in part at least one company. In a quip, “a search engine advertisement for performance sale.”

Microsoft Visual Basic Professional is one such database programming language useful in the procurement of source code and XML tabular data is as well effective as HTML within visual interface templates for the internet and creation of outputs desirable for Data Feed Cyclical Operation.

### Algorithm

It is formerly known in prior art that Yahoo! Inc. uses a system of vectors to achieve results in search query databases that include histograms. However, economics, calculus, permutations and resulting algorithmic properties often are intertwined in text book economic function and calculus quantitative theory solutions. For instance, a system for breaking down economic equations using calculus and Pascal's triangle can quickly result in rough polynomial algorithm solutions resembling the work of simulating fluctuations in financial security price rate performance analysis bond tables. One could use this information in a computer algorithmic form to make decisions. The solutions in calculus, economics and permutation algorithms in the present invention are exact to the exemplary needs and are equally as useful in transitioning data feed cyclical operation in an economic pay search engine database query, Internet Protocol Address “in common” geographical address resultants, and data search queries to the expert mathematician or computer scientist in source code solutions. By examining a curvilinear output or exertion, for example, the algorithm curve to resemble a smooth curve, then each point on the curve can be the fundamental economic equivalent of at least one product identifier economic paid price advertisement consumed by user preference at any point in time there is a consumer user action.

There is an allowance in mathematical models to go further in optimizing the landing page and in market analysis trending in calculus allowing for the derivative or rate of change at any given point in time or recorded over time to play in at least some part of decisions. While also having the economic demand price value from two points in the same direction (a to b) using the fundamental theorem of integral calculus as a positive or negative reaction in demand. The practice of page placement or accuracy of the landing pages is a permutation listing at least one like attribute identifier, such as, a keyword, location, or price across two or more of the same or similar algorithms to provide a result of poor quality and high quality results in the final result placement on the search engine query user query result page as well as height in the listing.

The first part of the curvilinear derivative placement is considered minima or the last placement. And the last part of the curvilinear derivative placement is the number one listing known as maxima. There are also several graphical advantages to a unified system based on economic and quantitative analysis. The integral of the rate of change of the example exerted or exact curvilinear graph between two time points (a and b) would result in a histogram, having both a width determined by time (a and b) and the height which would be the Integrated quantity using the Fundamental Theorem of Calculus to describe the volume or amount of demand. The derivative at the point of demand chosen is the velocity of the demand. And the second derivative at the point of demand is the acceleration for the desired product identifiers in any one group. In a third dimension, the various changes could be graphed according to performance and time and the derivative of that curve will provide sale performance. The present invention algorithm is based upon paid advertisements by geographical and market analysis. By using this method and an exemplary exerted smooth curvilinear graph, the result is the landing page of highest economic efficiency or “what sells” and “price performance analysis” using consumer preference actions.

Microsoft Visual Basic Professional is an example which is used for mathematical and economic source code.

### Internet Protocol Address Location

It is commonly known in prior art of Web, Inc. to use internet protocol standards to utilize the needs for software packaging and transfer. Further, the use of protocol standards was established by the “DoD in 1990.” The present invention harvests “in common” standards at nodes and switches to name clusters of similarities in trending customer actions and choosing geographic location names based on advertiser needs for best results in new market and future market reach. The development of geographic location will allow advertising participants to choose geographic location proportionate to the price paid for additional regional enlargement while achieving the best results of where “it's working” The search engine database receives and ideally denotes nodes and switch geographic location based on established standards.

The product of the metadata of the present invention provides a unique system for creating significant changes to allow users to benefit by selecting algorithmic points to provide range free services to anyone within an advertiser selecting geographic grouping of local zip codes. This is significant although the changes forthcoming are economically based and therefore herein are the presentations of mathematical and purchasing theory which can be utilized for the best results to locate at least one product at advertiser selected groupings of maxima, minima, and in between geographic preferences such as to maximize the limit purchase price in between said geographic preferences and achieve an excellent economic result to optimally, at best, edify the internet gross national or domestic product in theoretic economics permissible at least one search engine result to provide mutual participant market capitalization. In the free market system of a search engine it is especially important to have at least a nominal fee to assist various companies in deciding how to spend their advertising dollars. The ultimate provision to do this is to enable the search engine to focus on looking at gross national or domestic search engine internet purchasing products as an exemplary method to keep the greater product interest output from the United States or regions with special creativity to gain advantage by heightening their listing in the search engine, for example. However, country based blocking and buying therein and cross-marketing are not out-ruled in the search engine of the present invention, a query is made to suggest a users preference and input data is extracted from a previously product set template created by the information provider which results as a listing from at least one permutation of at least one mathematical model which enables advertisers to limit what geographic area they desire to advertise in. Said mathematical model is conceptual to provide input data which is selected and tracked within a database associated with the search engine via aggregate statistics including, but not limited to, tracking computer cookie code conversion analysis of a user's prior computing habits and in which geographic area the user is most likely to respond to local advertising. A ranking appears as at least one permutation of goods assigned from product user template extracted sets of at least one computer binary operation. The computational input information template computer user interface may provide at least one user computer network flow output for computer user performance analysis which enables the search engine to set desired advertising rates depending upon the geographic location purchased by the advertiser, so that the extent of the geographic location allowing user access to the advertiser depends upon the price paid by the advertiser to appear upon the search engine as a query result displayed in response to a user inquiry of a subject displayed upon the search engine.

Embodiments of the present invention comprise methods that facilitate query results ranking and permutation therein to provide mathematical models which are suggestive examples of unifying principles to create an optimal system for gross domestic, foreign, or inclusive product output of advertiser products, using the fundamental algorithmic graphs, thereby providing a great basis for software development to maximize potential, such as but not limited to, conversions, through internet software located through at least one internet search engine, an advertising computer system database configuration and user profile interface configuration which be incorporated as useful search query results. The results of at least one method herein are displayed on users computers, mobile phones, mobile workstations, including work stations that include at least one server and personal digital assistants through touch-screens, voice commands, or keyboards, each having hard, high-density, optical or laser drives with at least on computer processing unit (CPU) and having sufficient random access memory (RAM), a binary operating system and at least one high speed satellite, cellular, Internet Protocol telephony, or land-line, such as cable communications, system having at least one modem or transmitter/receiver internet capability, and at least one unit demand, including high-speed local company networks which are used upon the internet search engine advertising company controls.

The computer workflow environment of the present invention has at least one commercial internet search engine communicating with a user's workstation computer via at least one network adapter having connectivity to at least one internet search engine user template interface workstation computer having at least one user using at least one internet search engine profile accessing at least one open transmission and reception communication via at least one network adapter. A method for at least one internet search engine database computer system includes the step of providing interactive computational flowing network software comprising; a.) at least one binary operation upon; b.) at least one algorithm; c.) at least one template extracted data advertiser resource storage; and d.) at least one permutation or combination listing an extracted data query list; wherein at least one placement extracted data appears to a consumer on said internet search engine as being query organized.

In the computer workflow environment which has permutated data algorithmic data points which are economically desired, reaching gross national or domestic internet product effective said internet search engine at least one query listed free market share system having appropriate amount alternate, mixed, maxima, and minima query result pages and listings per page wherein the proportionate economic price paid provides optimal respective advertiser economic payee size the equality for search queries reaching users through search query results displayed as advertised wherein search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area wherein associating the fee charged maximizes advertiser payee desire necessary periodic or continuous said internet search engine database calculated adjustments for proportionate fee advantageously providing market reach capable and desired by advertiser's size said proportionate geographic fee.

In the computer workflow environment the template extracted data query list can be product related and has consumer preferential tracking of a search query which is categorically accessed by website or keyword input search or selected from a list by the user of the search engine.

In the computer workflow environment the template extracted data query list can be service related and has consumer preferential tracking of a search query which is categorically accessed by website or keyword input search or selected from a list by a user of the search engine.

In the computer workflow environment the template extracted data query list is information related including consumer preferential tracking of a search engine query which is categorically accessed by website or keyword input search or selected from a list;

In the computer workflow environment the permutated or combined extracted data query list is at least one product which is preferentially tracked;

In the computer workflow environment the permutated or combined extracted data query list is at least one service which is preferentially tracked;

In the computer workflow environment the permutated or combined extracted data query list is at least one information which is preferentially tracked;

In the computer workflow environment the at least one binary operative displays at least one data, such as but not limited to, a service, a product, or information rank which is tested amongst users in a tracked database which separates advertiser at least on price classification manipulated by the computer, the price of which depends upon the extent of the advertiser's choice of the extent of the search engine geographic correlated to the advertiser's choice to pay for a predetermined geographic extent of the advertiser's advertisement being visible by a user in an advertiser selected geographic region.

In the computer workflow environment the permutated or combined said extracted data list is automated updated via tracking analysis of user habits such as but not limited to, permutated updated data wherein recalculation updates, such as but not limited to, rank;

In the computer workflow environment the permutated or combined data points reaches a price associated with a percentage of gross national product effective to the internet search engine which is to provide at least one query associated with advertiser geographic preference listed as maxima;

In the computer workflow environment the permutated or combined data points reaches a price associated with a percentage of gross national product effective to the internet search engine which is to provide at least one query associated with advertiser geographic preference listed as minima;

In the computer workflow environment the permutated data search engine results are assigned an internet location to a specific at least one part of a country;

In the computer workflow environment the permutated data search engine displays at least one query listed result which is assigned an internet location cross-market across at least one part countries;

In the computer workflow environment the database and workflow is established on users computers, mobile phones, mobile workstations, including work stations that include at least one server and personal digital assistants through touch-screens, voice commands, or keyboards, each having hard, high-density, optical or laser drives with at least one computer processing unit (CPU) and sufficient random access memory (RAM), a binary operating system and at least one high speed satellite, cellular, Internet Protocol telephony, or land-line, such as cable, at least one modem or transmitter/receiver internet capability, and at least one said unit demand, including high-speed local company networks, upon which the internet search engine advertising company advertiser controls are displayed.

In the computer workflow environment includes alternate pages containing various levels having mixed or fixed maxima, minima, and between results pages depending upon advertiser-selected prices, various page IP Addresses, Global Positioning, and Mobile harvested standards allowing apt names includes information harvested standards allowing apt names includes information containing geographical location and market audience sizes, and econometric pricing across various levels, the search engine page states, national pages, wherein include limitations or additions to variables, to optimize profit by allowing computer users access to affordable choices upon performance, wherein the advertisers select a predetermined geographic location which will display the advertiser's advertisement upon the search engine, depending upon the price associated with the geographic location of users having access to the advertiser's advertisement.

In the computer workflow environment as in Claim 1 wherein search engine database receives and ideally denotes nodes and switch geographic location based on established Internet Protocol Address standards Global Positioning System and Mobile;

In the computer workflow environment as in Claim 1 wherein the template is at least in part an advertising form;

In the computer workflow environment as in Claim 1 wherein the method applied is a cyclical data feed;

In the computer workflow environment as in Claim 1 wherein the method uses call to action based on product, information, service or the like identifiers in an organized database;

In the computer workflow environment as in Claim 1 wherein the method provides useful graphical economic and algorithmic performance data on a computer display.

### OBJECTS OF THE PRESENT INVENTION

It is an object of the present invention to provide exemplary aspects to create software that can be used easily by users in advertiser selected geographic locations having access to the advertiser's geographic results.

It is a further object of the present invention to provide easy manufacturing of software.

It is still a further object of the present invention to provide the drawings and specification herein to enable the computer software system networks to have equitable advertiser pricing based on the highest principles.

It is yet a further object of the present invention to provide the drawings and specification herein to enable the computer software system networks to have a lesser hierarchy of advertiser placement upon a display of a search engine using at least some of the principles herein.

### BRIEF DESCRIPTION OF THE DRAWINGS

The present invention can best be understood in connection with the following drawing, in which:

FIG. 1 is a two-dimensional flow chart view of an algorithmic permutation or combination attribute processor.

FIG. 2 is a two-dimensional flow diagram of an algorithmic attribute processor.

FIG. 3 is a two-dimensional flow diagram of an automated cyclical economic payment data feed.

### DETAILED DESCRIPTION OF THE DRAWINGS

In order to provide the equitable advertising pricing scheme wherein an advertiser can maximize his exposure on a geographically-limited portion of a search engine, the advertiser pays a set price for a predetermined number of geographic units, such as one or more zip codes associated with the search engine users.

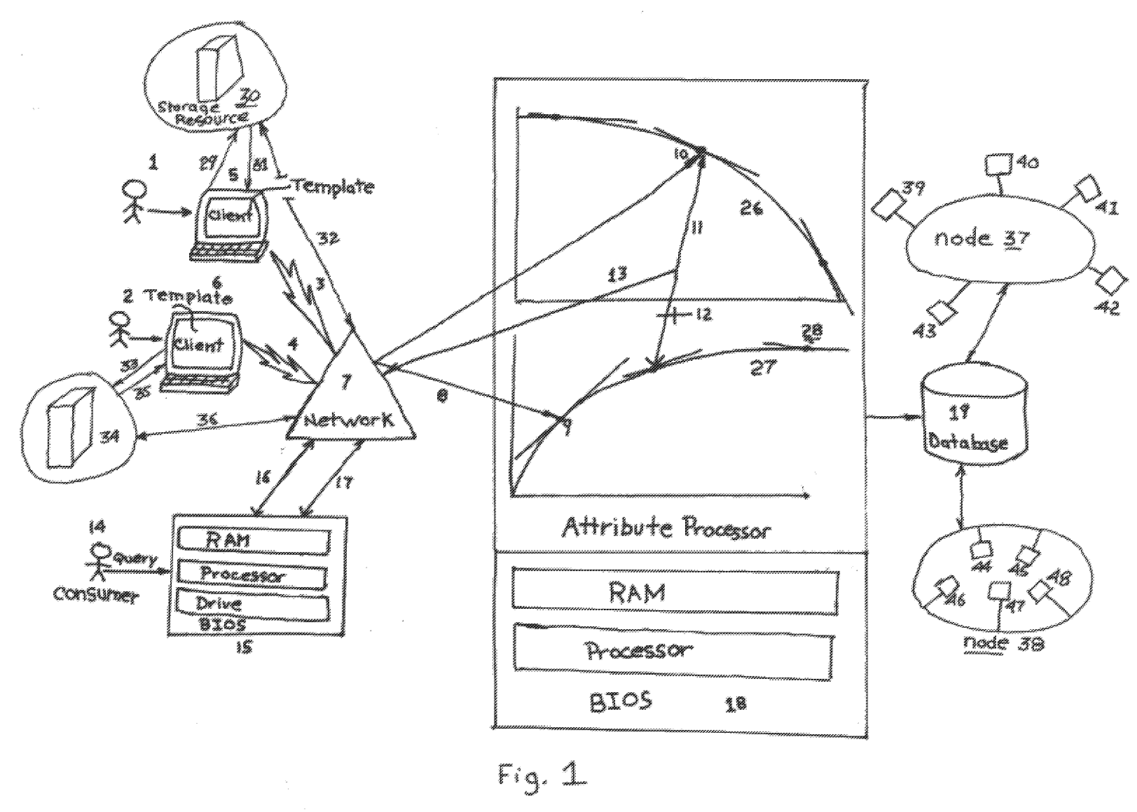

For Example, FIG. 1 has client 1 working on client template computer 5 and client 2 working on client template 6 delivering extracted template data 3 and 4 via a network 7 to algorithm curve examples 26 and 27 each having projected template extracted data results of example derivatives to project a tangent of the algorithm on respective relative data points 9 and 10. A permutation or combination 11 of such data points receive a determinant value 12 and are delivered 13 to the network. The projected data may regard at least one data, such as rank, via network connection 3 and 4 to clients 1 and 2. The results of attribute algorithmic processing 13 is done on a database 19 having a BIOS Ram and Processor 18. A sample query is made by consumer 14 through a computer having Ram Processor Drive and BIOS 15 via connection and signal 16 to network 7 and database 19 resulting in at least one search engine query organized result applicable to product, service, or information previously processed and computed by clients 1 and 2. This is merely a simple example through the examination of exemplary algorithmic curves 26 and 27 based on calculus. Curves 26 and 27 derivatives 9 and 10, both tangents to the curve, provide a glance at search engine listing placement wherein each derivative represents a search engine list placement on at least one website page of some dimension allowing only a certain amount of at least some listings per page. For example, maxima listing 28 is page number one and listing one of consumer 14 viewing website page upon a query resulting action and delivery 17.

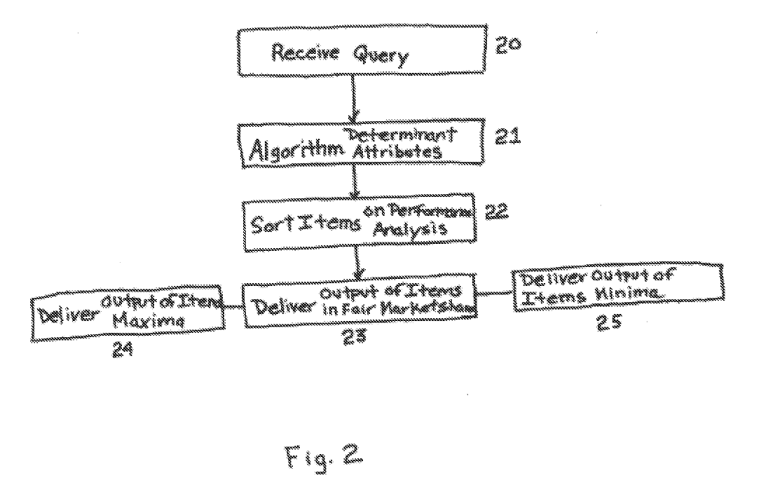

FIG. 2 A query is received 20 and an algorithm determinant attribute 21 allows sorting and organizing performance at least one search engine listing sorted at least one time on performance analysis, such as but not limited to, tracking a conversion, resulting in a fair market-share output of items 23 or alternatively an extreme output of maxima delivery 24 or minima delivery 25.

Referring Back to FIG. 1, Client 1 creates an advertisement and accesses 29 the template to integrate identifiers on storage resources 30 communicating back to Client 31 and interactive computational network communication search engine flow 32 for organizing sorted lists of client data. Client 2 creates an advertisement and accesses the template to integrate identifiers 35 on storage resources 34 communicating back to Client 35 and entering the network 36 for computational sorting economically and mathematically through the attribute processor in competition with Client 1. Node 37 has mutually exclusive locality Internet Protocol Addresses 39, 40, 41, 42, and 43, as part of the consumer network applied upon database 19. Node 38 have mutually and inclusively locales based on passing a switch to inner geographical areas at Internet Protocol Addresses 44, 45, 46, 47, and 48 upon database 19.

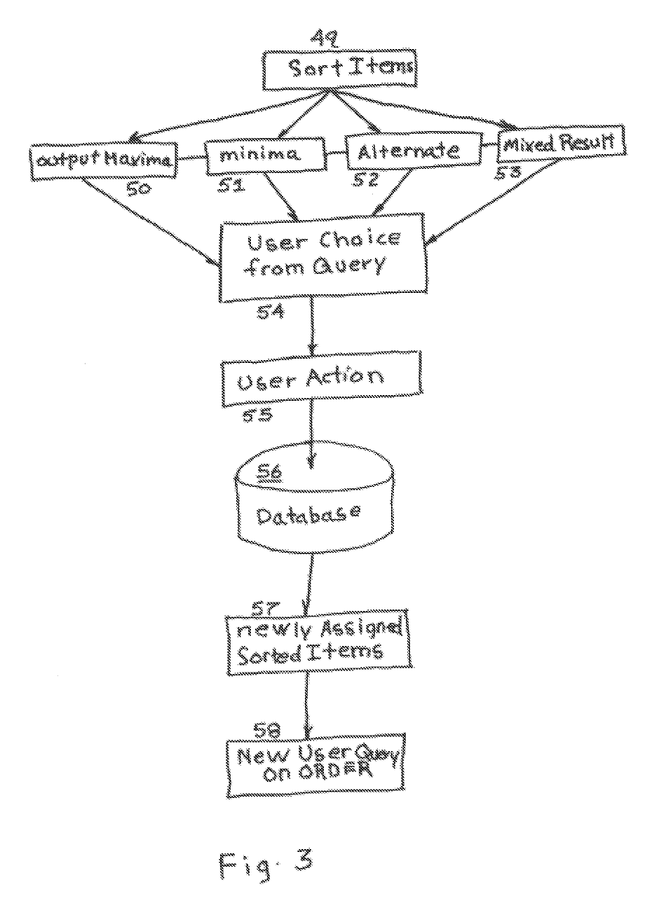

FIG. 3 addresses the permutated sorted list 49 and the output choices to consumers having various types which are labeled exemplary as output maxima 50 minima 51 alternate to provide the consumer choice of other quality listings 52 and high performing and low performing listings in a mixed result 53. The consumer user choice from the query listing of an advertisement 54 results as an example the conversion of buying a product 55 and the action is updated, listed and permutated as higher or lower rank in database 56 which makes continuous calculations to assign the action 55 a new listing in the sort of permutated data 57 and deliver the new order to the next consumer of a search inquiry 58.

As a result of the aforesaid algorithmic determination of what price an advertiser will pay in a predetermined geographic location, the advertiser can maximize his exposure upon a portion of the search engine associated with the geographic location, so that the advertiser pays less than advertiser would pay to advertise in a larger geographic location associated with the search engine.

It is further noted that the aforesaid example, are not limited to what is explicitly mentioned and that the scope of the invention is fundamental in the following claims:

I claim:

1. In a computer workflow environment having at least one commercial internet search engine workstation computer via at least one network adapter thereto, said workstation computer having connectivity with at least one internet search engine user template interface, said workstation computer having at least one user using at least one internet search engine profile accessing at least one open transmission and reception communication via at least one network adapter, wherein a method is provided for at least one internet search engine database computer system which includes interactive computational flowing network software, said computer workflow environment comprising:
I.) At least one binary operation upon;
II.) At least one algorithm;
III.) At least one template extracted data advertiser resource storage;
IV.) At least one permutation or combination listing said extracted data query list;
Wherein at least one placement extracted data appears to a consumer to be displayed on said internet search engine query which is organized by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

2. In the computer workflow environment as in claim 1 wherein said permutated data algorithmic data points are economically desired, reaching gross national or domestic internet product effective said internet search engine at least one query listed free market share system having appropriate amount alternate, mixed, maxima, and minima query result pages and listings per page wherein the proportionate economic price paid provides optimal respective advertiser economic payee size the equality for search queries reaching users through search query results displayed as advertised wherein search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area wherein associating the fee charged maximizes advertiser payee desire necessary periodic or continuous said internet search engine database calculated adjustments for proportionate fee advantageously providing market reach capable and desired by advertiser's size said proportionate geographic fee.

3. In the computer workflow environment as in claim 1 wherein template extracted data query list is product related consumer preferential tracking categorically accessed by website or keyword input search or selected from a list by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

4. In the computer workflow environment as in claim 1 wherein the template extracted data query list can be service related and has consumer preferential tracking of a search query which is categorically accessed by website or keyword input search or selected from a list by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

5. In the computer workflow environment as in claim 1 wherein the template extracted data query list is information related including consumer preferential tracking of a search engine query which is categorically accessed by website or keyword input search or selected from a list by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

6. In the computer workflow environment as in claim 1 wherein the permutated or combined extracted data query list is at least one product preferentially tracked by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

7. In the computer workflow environment as in claim 1 wherein said permutated or combined extracted data query list is at least one service preferentially tracked by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

8. In the computer workflow environment as in claim 1 wherein said permutated or combined extracted data query list is at least one information preferentially tracked by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

9. In the computer workflow environment as in claim 1 wherein at least one binary operative displays at least one data, such as but not limited to, a service, a product, or information rank which is tested amongst users in a tracked database by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

10. In the computer workflow environment as in claim 1 wherein permutated or combined said extracted data list is automated updated via tracking analysis of user habits such as but not limited to, permutated updated data wherein recalculation updates, such as but not limited to, rank by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

11. In the computer workflow environment as in claim 1 wherein said permutated or combined algorithmic data points reaches gross national product effective said internet search engine at least one query listed maxima by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

12. In the computer workflow environment as in claim 1 wherein said permutated or combined algorithmic data points reaches gross national product effective said internet search engine at least one query listed minima by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

13. In the computer workflow environment as in claim 1 wherein said permutated data search engine results are assigned an internet location to a specific at least one part of a country by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

14. In the computer workflow environment as in claim 1 wherein permutated data search engine displays at least one query listed result which is assigned an internet location cross-market across at least one part countries the price of which depends upon the extent of the advertiser's choice of the extent of the search engine geographic correlated to the advertiser's choice to pay for a predetermined geographic extent of the advertiser's advertisement being visible by a user in an advertiser selected geographic region.

15. In the computer workflow environment includes as in claim 1 wherein alternate pages containing various levels having mixed or fixed maxima, minima, and between results pages depending upon advertiser-selected prices, various page IP Addresses, Global Positioning, and Mobile harvested standards allowing apt names includes information containing geographical location and market audience sizes, and econometric pricing across various levels, the search engine page states, national pages, wherein include limitations or additions to variables, to optimize profit by allowing computer users access to affordable choices upon performance by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

16. In the computer workflow environment as in claim 1 wherein search engine database receives and ideally denotes nodes and switch geographic location based on established Internet Protocol Address standards Global Positioning System and mobile by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

17. In the computer workflow environment as in claim 1 wherein the template is at least in part an advertising form by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

18. In the computer workflow environment as in claim 1 wherein the method applied is a cyclical data feed by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

19. In the computer workflow environment as in claim 1 wherein the method uses call to action based on product, information, service or the like identifiers in an organized database by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

20. In the computer workflow environment as in claim 1 wherein the method provides useful graphical economic and algorithmic performance data on a computer display by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.

21. In the computer workflow environment as in claim 1 wherein the method supplies additional methods to the advertiser for advertising cost such as market analysis cost wherein the price of the advertisement is reduced due to supply overcoming demand, a cost-per-click, or other advantageous payment determinant having the same economic solution by search query results correlated to advertisers paying a predetermined price for access to users using said search engine within a geographic location associated with a price paid by an advertiser associated with the user's search query so that the price which the advertiser pays within said predetermined geographic are proportionate with the extent of the size of the geographic area.
